(19) United States
(12) Patent Application Publication
(10) Pub. No.: US 2024/0075745 A1
(43) Pub. Date: Mar. 7, 2024

(54) PRINTING APPARATUS AND PRINTING APPARATUS BODY

(71) Applicants: Masatoshi ISHIDA, Kanagawa (JP); Tomoya FUJII, Kanagawa (JP); Munekazu HIRATA, Tokyo (JP); Kanako ISHIGURE, Tokyo (JP)

(72) Inventors: Masatoshi ISHIDA, Kanagawa (JP); Tomoya FUJII, Kanagawa (JP); Munekazu HIRATA, Tokyo (JP); Kanako ISHIGURE, Tokyo (JP)

(73) Assignee: Ricoh Company, Ltd., Ohta-ku, Tokyo (JP)

(21) Appl. No.: 18/260,894

(22) PCT Filed: Jan. 31, 2022
(86) PCT No.: PCT/IB2022/050796

§ 371 Date: Jul. 10, 2023

(30) Foreign Application Priority Data
Mar. 19, 2021 (JP) 2021-045430

(51) Int. Cl. B41J 2/175

(52) U.S. Cl. CPC B41J 2/1752; B41J 2/17546

(57) ABSTRACT

A printing apparatus includes a removable member including a printing unit, a battery that drives the printing unit, a control board that controls the printing unit, and a body unit that holds the removable member, the battery, and the control board. The removable member and the battery are disposed on a straight line extending in a sub-scanning direction perpendicular to a main scanning direction of the body unit. The control board is disposed in the body unit with a side, as a facing side, of the control board being along a height direction of the printing apparatus and facing the removable member and the battery in the main scanning direction.

### TECHNICAL FIELD

Embodiments of the present disclosure relate to a printing apparatus and a printing apparatus body.

### BACKGROUND ART

Patent Literature (PTL) 1 discloses a printing apparatus in which a substrate and a built-in power supply are disposed above an ink cartridge.

### CITATION LIST

### Patent Literature

[PTL 1]
Japanese Unexamined Patent Application Publication No. 2018-051814

### SUMMARY OF INVENTION

### Technical Problem

However, a taller printing apparatus having a configuration of PTL 1 is likely to be lifted or tilted from a recording medium, which is subjected to printing, while moving. In short, the taller printing apparatus exhibits a poor operability.

It is an object of the present invention to provide a printing apparatus that is downsized in height and exhibits a good operability.

### Solution to Problem

A printing apparatus includes a removable member including a printing unit, a battery that drives the printing unit, a control board that controls the printing unit, and a body unit that holds the removable member, the battery, and the control board. The removable member and the battery are disposed on a straight line extending in a sub-scanning direction perpendicular to a main scanning direction of the body unit. The control board is disposed in the body unit with a side, as a facing side, of the control board being along a height direction of the printing apparatus and facing the removable member and the battery in the main scanning direction.

A printing apparatus body includes a removable-member storage unit, a battery storage unit, a control board holder, and a body unit. The removable-member storage unit stores a removable member that includes a printing unit. The battery storage unit stores a battery that drives the printing unit. The control board holder holds a control board that controls the printing unit. The body unit has an opening portion that exposes the printing unit. The removable-member storage unit and the battery storage unit are disposed on a straight line extending in a sub-scanning direction perpendicular to a main scanning direction of the body unit. The control board holder is disposed in the body unit to hold the control board with a side of the control board being along a height direction of the printing apparatus body and facing the removable-member storage unit and the battery storage unit in the main scanning direction.

### Advantageous Effects of Invention

Accordingly, the printing apparatus is provided that is downsized in height and exhibits a good operability.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is an overall left perspective view of a printing apparatus according to an embodiment of the present disclosure.

FIG. 2 is an overall bottom perspective view of the printing apparatus when a head cover is opened.

FIG. 3 is an overall left perspective view of the printing apparatus when a top cover is opened.

FIG. 4 is a diagram illustrating the printing apparatus, with an ink cartridge and a battery removed from the printing apparatus.

FIG. 5 is a diagram illustrating a top-cover opening/closing detection unit.

FIG. 6 is a diagram illustrating an ink cartridge storage unit and a battery storage unit.

FIG. 7 is a diagram illustrating how an ink cartridge, a battery, and a control board are mounted.

FIG. 8 is a diagram illustrating an ink cartridge terminal and the control board.

FIG. 9 is a diagram illustrating the ink cartridge, the ink cartridge terminal, and the control board.

FIG. 10 is a diagram illustrating the battery, a battery terminal, and the control board.

FIG. 11 is a diagram illustrating the ink cartridge, the battery, and the control board in a height direction of the printing apparatus.

FIGS. 12A to 12C are diagrams illustrating an example of how to hold the printing apparatus to open the head cover.

FIG. 13 is a diagram illustrating an example of how to hold the printing apparatus for printing.

FIG. 14 is an illustration of an accumulated print button.

FIG. 15 is a diagram illustrating an arrangement of a power button and a print button.

FIG. 16 is an overall perspective view of a printing apparatus according to another embodiment of the present disclosure.

### DESCRIPTION OF EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. For the sake of simplicity, like reference numerals are given to identical or corresponding constituent elements such as parts and materials having the same functions, and redundant descriptions thereof are omitted unless otherwise required. As used herein, the term “connected/coupled” includes both direct connections and connections in which there are one or more intermediate connecting elements. Referring now to the drawings, embodiments of the present disclosure are described below.

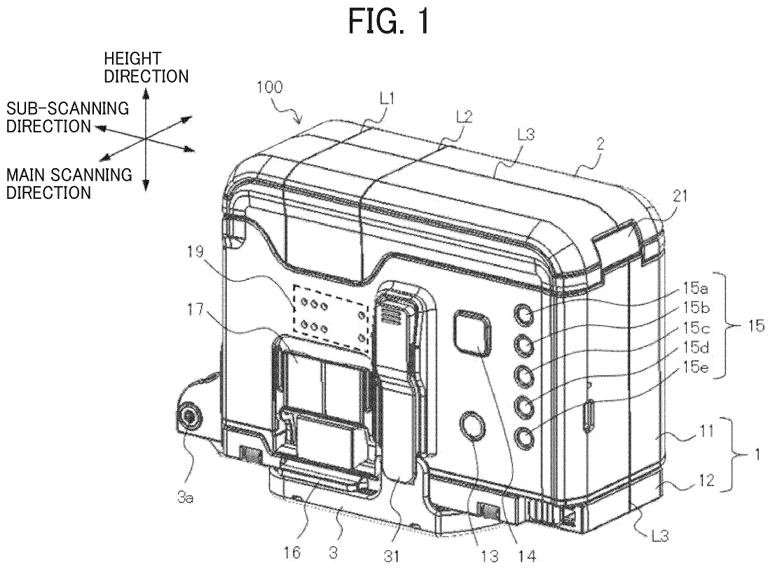

FIG. 1 is an overall view of a handheld mobile inkjet printer (HMP) 100 serving as a printing apparatus according to an embodiment of the present disclosure. Specifically, FIG. 1 is an overall left perspective view of the HMP 100. In the following description, a “printing apparatus” refers to a configuration having a removable member including a printing unit described later; whereas a “printing apparatus body” such as a printing apparatus body 10 illustrated in FIG. 1 refers to a configuration excluding, from the printing apparatus, the removable member including the printing unit.

The HMP 100 includes a body unit 1, a top cover 2, and a head cover 3. The HMP 100, in a substantially rectangular parallelepiped shape as a whole, has a length in a main scanning direction to such an extent that a user can hold the HMP 100 with a palm. Note that the main scanning direction is a printing direction of the HMP 100.

According to the present embodiment, the body unit 1 includes an upper unit 11 and a lower unit 12. The lower unit 12 is removably mountable relative to the upper unit 11.

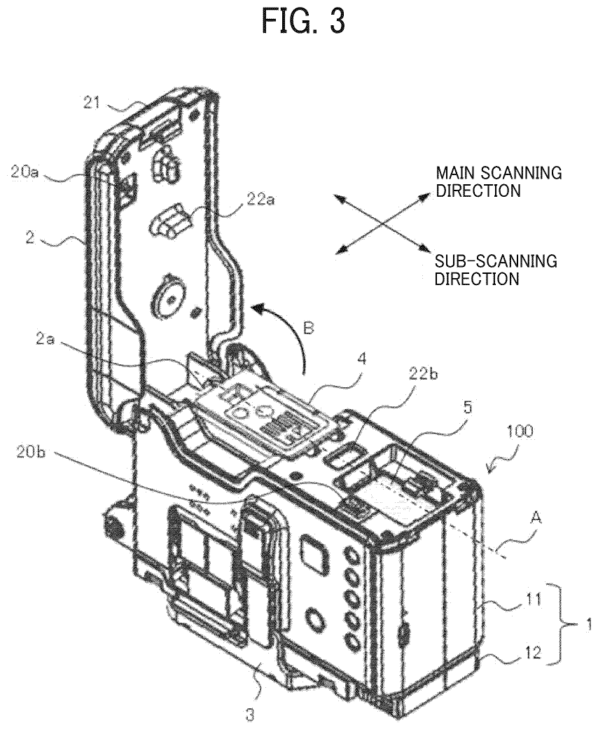

Alternatively, the lower unit 12 and the upper unit 11 may construct a single unit. The top cover 2 is openably closable with respect to the upper unit 11. When the user presses a top cover opening/closing switch 21, the lock is unlocked. Thus, the top cover 2 is opened upward with a top-cover shaft 2a, which is disposed proximate to or in a front portion of the top cover 2 as illustrated in FIG. 3, as a fulcrum.

The head cover 3 is openably closable with respect to the lower unit 12. When the user presses an upper end portion of a head cover opening/closing lever 31, a claw unit disposed at a lower end portion of the head cover opening/closing lever 31 comes off from an engagement hole of the head cover 3. As a result, the head cover 3 is opened from a position below the body unit 1 to a position ahead the body unit 1 with a head-cover shaft 3a, which is disposed in a front portion of the upper unit 11, as a fulcrum. The head cover 3 serves as a printing-unit cover member according to the present embodiment. The head cover opening/closing lever 31 serves as a printing-unit-cover operation unit according to the present embodiment.

Operation keys such as a power button 13, a print button 14, and accumulated print buttons 15 are gathered together on one side of the upper unit 11 in the main scanning direction. In the present embodiment, such operation keys are gathered together on a left side of the upper unit 11.

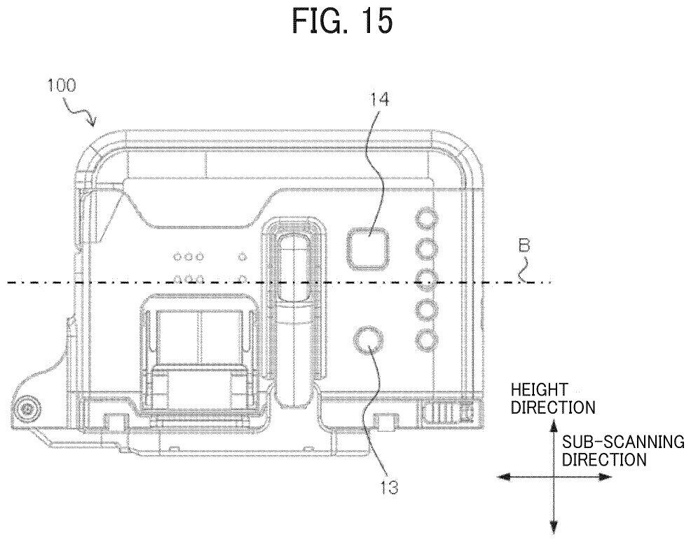

The power button 13 switches between ON and OFF of the power of the HMP 100 when the power button 13 is pressed. In order to prevent the power button 13 from being erroneously pressed during printing, the power button 13 is preferably located away from the top cover 2 that the user grips. For example, the power button 13 may be disposed at a relatively lower position in the back of the body unit 1 of the HMP 100. In the present embodiment, as illustrated in FIG. 15, the power button 13 is disposed below the center of the body unit 1 in a height direction of the body unit 1 indicated by one dot chain line B. The power button 13 serves as a power operation unit according to the present embodiment.

The print button 14 switches between the start and standby of printing performed by the HMP 100 when the print button 14 is pressed. In order to facilitate pressing during printing, the print button 14 is preferably located in a range that can be reached by the thumb of the user with the palm of the user placed on the top cover 2. For example, the print button 14 may be disposed at a relatively upper position in the back of the body unit 1 of the HMP 100. In the present embodiment, as illustrated in FIG. 15, the print button 14 is disposed above the center of the body unit 1 in the height direction of the body unit 1. The print button 14 serves as a print instruction unit according to the present embodiment.

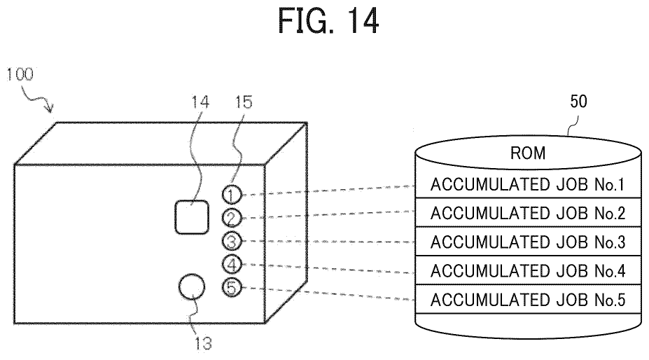

The accumulated print buttons 15 include a plurality of buttons 15a to 15e. As illustrated in FIG. 14, print information such as a print job is associated with each of the buttons 15a to 15e. The print information accumulated in a memory such as a read only memory (ROM) 50 is retrieved when the corresponding one of the buttons 15a to 15e is pressed. As illustrated in FIG. 1, the accumulated print buttons 15 are adjacent to the print button 14 in a sub-scanning direction on a side of the body unit 1.

Such a configuration shortens the stroke travelled by a finger of the user between an operation of selecting the print information and an operation of instructing the start of printing, thus enhancing the operability of the HMP 100. Note that the memory such as the ROM 50 is disposed inside the body unit 1. The accumulated print buttons 15 serve as a print information retrieval unit or print information retrieval units according to the present embodiment.

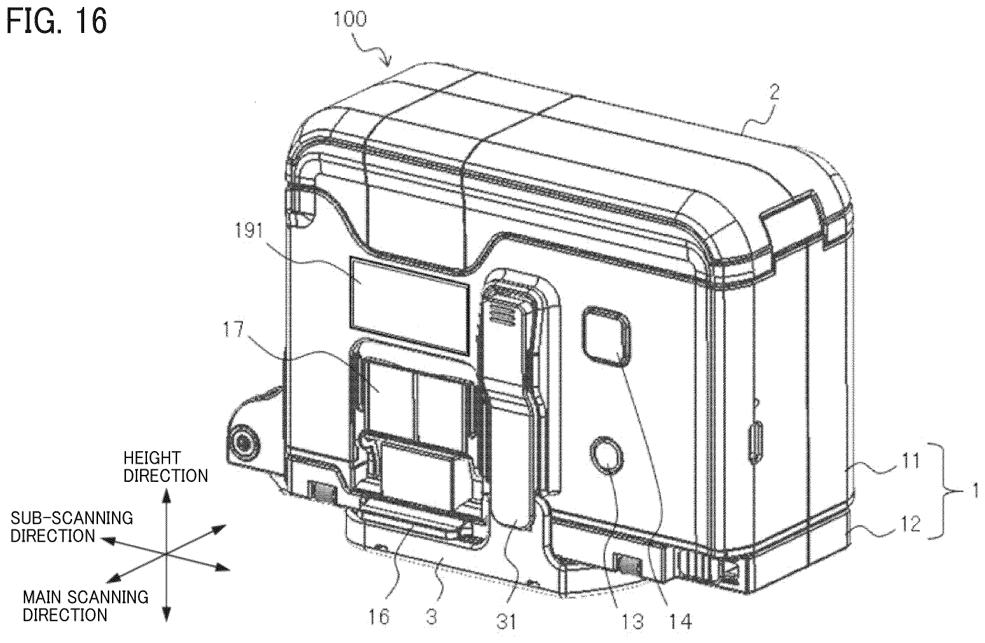

Note that the operation keys such as the power button 13, the print button 14, and the accumulated print buttons 15 are not limited to push-button switches as described above. For example, as illustrated in FIG. 16, a display screen 191 including, e.g., a touch panel may be disposed on the side of the body unit 1 provided with the power button 13 and the print button 14 so that the accumulated print buttons 15 are operated on the touch panel. The display screen 191 serves as a display unit according to the present embodiment.

The lower unit 12 includes a first index member 16 projecting from a side of the lower unit 12 in the main scanning direction of the HMP 100. The first index member 16 is a member serving as a mark indicating a printing start position when the user places the HMP 100 on a recording medium. The first index member 16 has a length in the sub-scanning direction perpendicular to the main scanning direction equal to a print width of the printing unit, which is a print width of a head that performs inkjet recording in the present example.

The upper unit 11 includes a second index member 17 that is disposed near the first index member 16 and can be folded to be housed in the upper unit 11. The second index member 17 is a member that is drawn from the upper unit 11 and used by the user when necessary, for example, at the time of printing. The second index member 17 guides the HMP 100 in the main scanning direction so that the HMP 100 is correctly moved in a desired printing direction.

A light emitting diode (LED) display unit 19 is disposed on the side of the upper unit 11 near a storage of the upper unit 11. The second index member 17 is housed in the storage of the upper unit 11. The LED display unit 19 notifies the user of a printing malfunction, an erroneous operation, and a warning about the ink level or the battery level, for example. In order to facilitate visual recognition for the user, the LED display unit 19 is preferably disposed at a position at which the LED display unit 19 is not hidden by the hand of the user. For example, the LED display unit 19 may be disposed at a position in a front portion of the body unit 1 of the HMP 100. Note that the LED display unit 19 may be replaced with the display screen 191 illustrated in FIG. 16. In this case, instead of the LED display unit 19, the display screen 191 may display, e.g., the above-described warning of which the LED display unit 19 notifies the user.

The top cover 2 has two parallel lines L1 and L2 extending from a left side of the top cover 2 to a right side of the top cover 2 via a top side of the top cover 2. An interval between the lines L1 and L2 corresponds to the print width of the head that performs inkjet recording, thus serving as a reference for the user to ascertain the print width when the user places the HMP 100 on the recording medium.

The top cover 2 also has a line L3 extending in a front-back direction on the top side of the top cover 2. The line L3 extends on front and back sides of the body unit 1 in addition to the top side of the top cover 2. The line L3 corresponds to a position of the head that performs inkjet recording. Specifically, the line L3 corresponds to a position of a nozzle row from which ink is discharged, thus serving as a reference for the user to ascertain the head position when the user places the HMP 100 on the recording medium.

The lines L1, L2, and L3 may be designed in advance in molds of the body unit 1 and the top cover 2 so that the lines L1, L2, and L3 are formed integrally with the body unit 1 and the top cover 2. Alternatively, the lines L1, L2, and L3 may be provided as stickers or stamped lines.

The lines L1, L2, and L3 are not limited to the lines described above. The line L3 may be provided alone, without the lines L1 and L2. Alternatively, the lines L1 and L2 may be provided without the line L3. The line L3 may be simply provided on the front and back sides of the body unit 1, without being provided on the top side of the top cover 2.

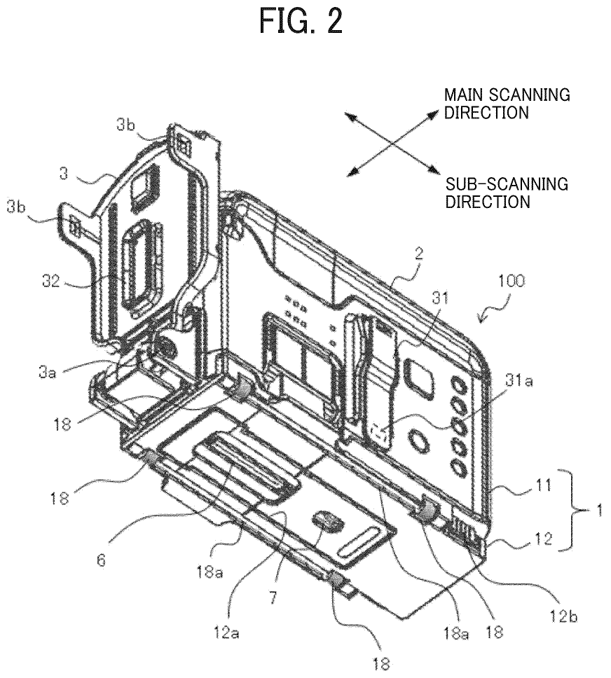

FIG. 2 is an overall bottom perspective view of the HMP 100 with the head cover 3 opened.

When the user presses the upper end portion of the head cover opening/closing lever 31, a claw unit 31a disposed at the lower end portion of the head cover opening/closing lever 31 comes off from an engagement hole 3b of the head cover 3. As a result, the head cover 3 is opened from the position below the body unit 1 to the position ahead the body unit 1 with the head-cover shaft 3a, which is disposed in the front portion of the upper unit 11, as a fulcrum.

The head cover 3 includes a head cap 32 inside. When the head cover 3 is closed, the head cap 32 covers a head 6 exposed on the bottom side of the body unit 1 to moisturize the head 6 and prevent printing failure due to clogging of the head 6 with ink.

The lower unit 12 of the body unit 1 has a rectangular opening 12a in a center portion of the lower unit 12. A face of a nozzle plate of the head 6 that performs inkjet recording and a detection face of a position sensor 7 that detects the position of the HMP 100 during printing are exposed from the opening 12a.

The head cover 3 protects the head 6 and the position sensor 7 in the opening 12a. The head cover opening/closing lever 31 that is operated to open the head cover 3 is disposed on the side of the body unit 1 provided with the power button 13 and the print button 14. The print button 14 and the head cover opening/closing lever 31 disposed on the same side of the body unit 1 shortens the stroke travelled by a finger of the user between an operation of opening the head cover 3 and the operation of instructing the start of printing, thus enhancing the operability of the HMP 100.

Note that the position sensor 7 is a sensor that detects the distance to the surface of the recording medium, the surface state (e.g., unevenness) of the recording medium, and the moving distance of the HMP 100. The position sensor 7 may be similar to a sensor used in an optical mouse (as a pointing device) for a personal computer, for example.

The lower unit 12 includes four rollers 18 in an area outside the opening 12a. A roller shaft 18a disposed in the sub-scanning direction perpendicular to the main scanning direction (i.e., the printing direction) of the HMP 100 supports the rollers 18, which support the movement of the HMP 100 in the main scanning direction.

The lower unit 12 is removably mountable relative to the upper unit 11. When the user slides an attachment/removal lever 12b disposed in a back portion of the lower unit 12, the upper unit 11 and the lower unit 12 coupled by a hook member is disengaged. Thus, the lower unit 12 is removed from the upper unit 11.

At the time of printing, with the head cover 3 kept open as illustrated in FIG. 2, the user places the HMP 100 such that a bottom side of the HMP 100, in other words, the head 6 faces the surface of the recording medium and moves the HMP 100 to print, e.g., an image on the recording medium.

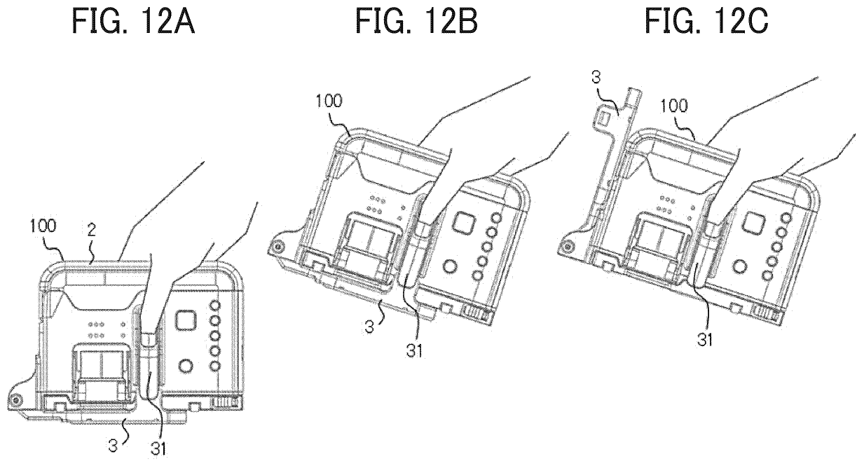

FIGS. 12A to 12C illustrate an example of how to hold the HMP 100 to open the head cover 3. When opening the head cover 3, the user places the palm on a top side of the HMP 100 (i.e., on the top cover 2) and grips the body unit 1 as illustrated in FIG. 12A. In this state, the user lifts the HMP 100 as illustrated in FIG. 12B. The head cover 3 is opened when the user presses, with the thumb, the upper end portion of the head cover opening/closing lever 31 disposed on the side of the body unit 1, as illustrated in FIG. 12C.

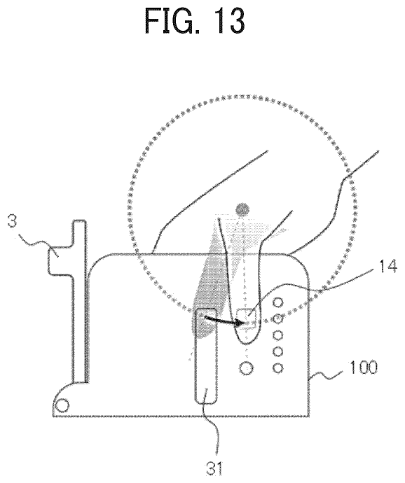

FIG. 13 illustrates an example of how to hold the HMP 100 to perform printing on a recording medium. When the user opens the head cover 3 and starts a printing operation, the user moves the thumb from the head cover opening/closing lever 31 to the print button 14 while gripping the body unit 1 with the palm placed on the top side of the HMP 100 and presses the print button 14 to cause the HMP 100 to start printing.

Note that the way of holding the HMP 100 at the time of printing is not limited to the way illustrated in FIG. 13. For example, in a case where the user performs printing on a surface of a recording medium disposed horizontally or in a case where the user performs printing while sitting on a chair, the user may feel easier to operate the HMP 100 with the palm placed on the back side of the body unit 1 to hold the HMP 100. In some cases, the user may feel easier to operate the HMP 100 with the palm placed on a corner between the top side of the body unit 1 and the back side of the body unit 1 to hold the HMP 100. The print button 14 is disposed allowing the user to hold the HMP 100 in various ways such as the ways described above.

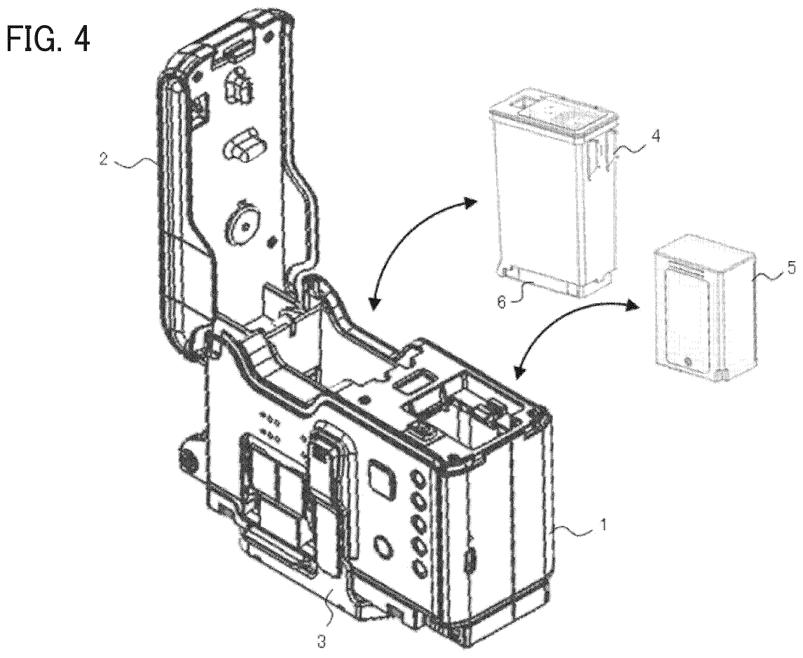

FIG. 3 is an overall left perspective view of the HMP 100 with the top cover 2 opened. FIG. 4 is a diagram illustrating the HMP 100, with an ink cartridge 4 and a battery 5 removed from the HMP 100.

When the user presses the top cover opening/closing switch 21, the top cover 2 is unlocked and opened upward in a direction B, which is a direction indicated by arrow B, with the top-cover shaft 2a, which is disposed proximate to or in the front portion of the top cover 2, as a fulcrum.

When the top cover 2 is opened, respective top sides of the ink cartridge 4 and the battery 5 appear, allowing the user to remove the ink cartridge 4 and the battery 5 from the body unit 1 as illustrated in FIG. 4 to replace the ink cartridge 4 and the battery 5 with new ones. In the present example, the head 6 is disposed at the bottom of the ink cartridge 4 as a part of the ink cartridge 4.

The ink cartridge 4 serves as a removable member according to the present embodiment. The battery 5 serves as a battery according to the present embodiment. The head 6 serves as a printing unit according to the present embodiment. The battery is not limited to a rechargeable battery. Alternatively, for example, the battery may be a dry battery.

The ink cartridge 4 and the battery 5 are disposed on a straight line A extending in the sub-scanning direction perpendicular to the main scanning direction of the body unit 1 (i.e., the main scanning direction of the HMP 100) as illustrated in FIG. 3.

The top cover 2 includes a switching projection unit 20a on an inner side of the top cover 2. The switching projection unit 20a is a part of an opening/closing detection unit that detects the opening or closing state of the top cover 2. When the top cover 2 is closed, the switching projection unit 20a contacts a filler member 20b disposed in the body unit 1. A detailed description of the opening/closing detection unit is deferred.

The top cover 2 further includes an ink-cartridge-pressure projection unit 22a on the inner side of the top cover 2 to apply pressure to the ink cartridge 4. The ink-cartridge-pressure projection unit 22a is a part of a pressure assembly that press the ink cartridge 4 toward an ink cartridge terminal, which will be described later.

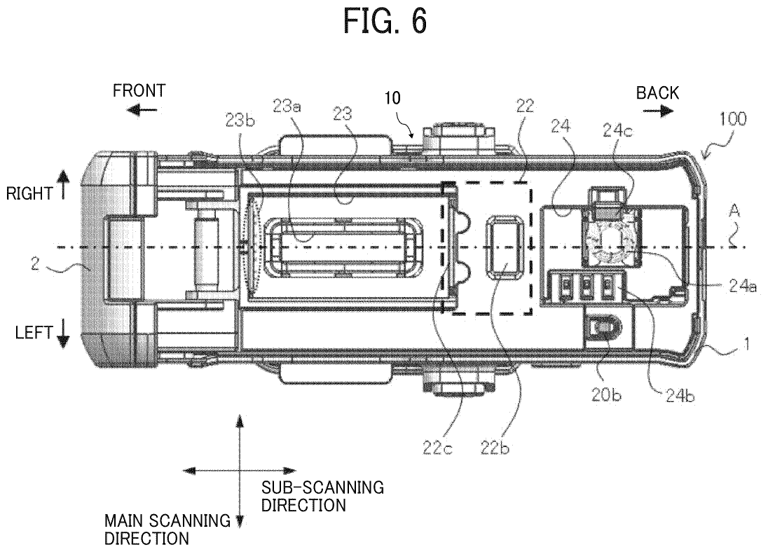

When the top cover 2 is closed, the ink-cartridge-pressure projection unit 22a contacts a contact unit 22b disposed in the body unit 1 and presses down the contact unit 22b into the body unit 1. Thus, the pressure assembly moves. A detailed description of the pressure assembly is deferred with reference to FIG. 6.

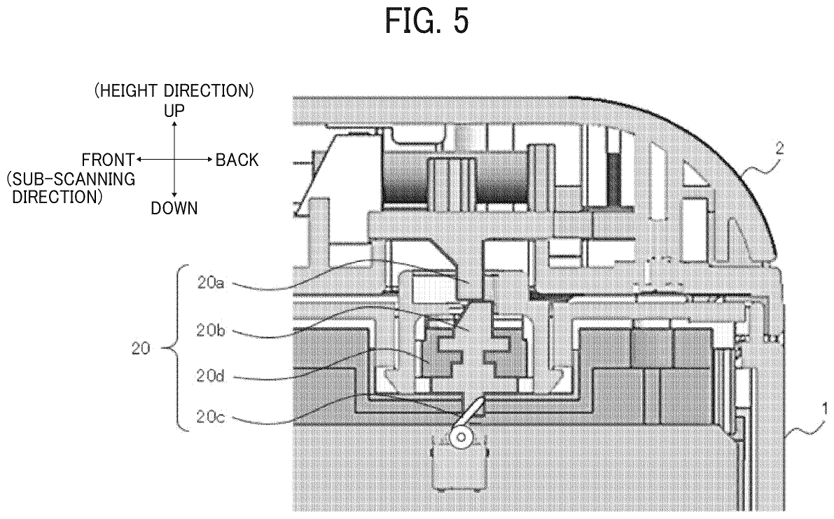

FIG. 5 is a diagram illustrating an opening/closing detection unit 20 that detects the opening or closing of the top cover 2. Specifically, FIG. 5 is a partial left cross-sectional view of the HMP 100, with the top cover 2 closed. As illustrated in FIG. 5, the up-down direction (i.e., vertical direction) is a height direction of the HMP 100; whereas the front-back direction is the sub-scanning direction.

The opening/closing detection unit 20 that detects the opening or closing of the top cover 2 includes the switching projection unit 20a, the filler member 20b, and a sensor 20c. The switching projection unit 20a is a member disposed on the inner side of the top cover 2 as described above. The switching projection unit 20a moves to and from the body unit 1 as the top cover 2 is closed and opened, respectively.

The filler member 20b is a member disposed in the body unit 1. The filler member 20b is located such that the switching projection unit 20a contacts the filler member 20b when the top cover 2 is closed. The filler member 20b is provided with a compression spring 20d. The body unit 1 supports the filler member 20b, allowing the filler member 20b to move up and down. The compression spring 20d keeps urging the filler member 20b upward.

The sensor 20c is a rotary switch disposed directly below the filler member 20b. The sensor 20c is turned on and off by the vertical (i.e., up and down) movement of the filler member 20b. Information detected by the sensor 20c is displayed on, e.g., the LED display unit 19 described above, to notify the user of the opening or closing state of the top cover 2.

The opening/closing detection unit 20 having the above-described configuration prevents the top cover 2 from being forgotten to be closed or from being used in a half-opened state.

FIG. 6 is a diagram illustrating an ink cartridge storage unit 23 and a battery storage unit 24. Specifically, FIG. 6 is a top view of the HMP 100, with the top cover 2 opened.

FIG. 6 illustrates a state of HMP 100 in which the ink cartridge 4 and the battery 5 are removed from the body unit 1. The body unit 1 includes an ink cartridge storage unit 23 that stores the ink cartridge 4 and a battery storage unit 24 that stores the battery 5. The ink cartridge storage unit 23 serves as a removable-member storage unit according to the present embodiment. The battery storage unit 24 serves as a battery storage unit according to the present embodiment. The ink cartridge storage unit 23 and the battery storage unit 24 are disposed on the straight line A extending in the sub-scanning direction perpendicular to the main scanning direction of the body unit 1 (i.e., the main scanning direction of the HMP 100).

The ink cartridge storage unit 23 has a given depth in the height direction of the HMP 100, which is a direction perpendicular to the main scanning direction and the sub-scanning direction. The bottom of the ink cartridge storage unit 23 is provided with a head opening portion 23a that exposes the head 6 disposed at the bottom of the ink cartridge 4 from a bottom side of the body unit 1. A lower portion of an inner front side of the ink cartridge storage unit 23 is provided with an ink cartridge terminal 23b that electrically connect to the ink cartridge 4.

The ink cartridge storage unit 23 is slightly longer than the ink cartridge 4 in the sub-scanning direction, to reduce friction between the ink cartridge terminal 23b and the ink cartridge 4 when the ink cartridge 4 is attached to or removed from the ink cartridge storage unit 23, thus reducing damage to or deformation of the ink cartridge terminal 23b.

On the other hand, the ink cartridge storage unit 23 longer than the ink cartridge 4 in the sub-scanning direction may cause an incomplete electrical connection between the ink cartridge terminal 23b and the ink cartridge 4. In order to prevent such an incomplete electrical connection, in the present embodiment, the pressure assembly is disposed that includes, e.g., the ink-cartridge-pressure projection unit 22a and the contact unit 22b as described above with reference to FIG. 3.

Specifically, a pressure assembly 22 is interposed between the ink cartridge storage unit 23 and the battery storage unit 24, as indicated by a broken line in FIG. 6, on the straight line A extending in the sub-scanning direction perpendicular to the main scanning direction of the body unit 1 (i.e., the main scanning direction of the HMP 100).

When the top cover 2 is closed, in the pressure assembly 22, the ink-cartridge-pressure projection unit 22a disposed on the inner side of the top cover 2 contacts the contact unit 22b disposed in the body unit 1 and presses down the contact unit 22b into the body unit 1. The pressure assembly 22 has a mechanism that converts the vertical movement of the contact unit 22b into the movement in the sub-scanning direction of a pressure member 22c. In other words, the pressure assembly 22 has a mechanism in which the contact unit 22b pressed down moves the pressure member 22c toward the front of the body unit 1.

Therefore, when the ink cartridge 4 exists in the ink cartridge storage unit 23, the pressure member 22c presses the ink cartridge 4 against the ink cartridge terminal 23b. Thus, the ink cartridge 4 is electrically connected to the ink cartridge terminal 23b.

The battery storage unit 24 has a given depth in the height direction of the HMP 100. The bottom of the battery storage unit 24 is provided with a pop-up compression spring 24a and a battery terminal 24b. The pop-up compression spring 24a urges a bottom side of the battery 5 upward. The battery terminal 24b electrically connects to the battery 5.

The battery storage unit 24 includes a stopper 24c as an upper portion of the battery storage unit 24. The stopper 24c contacts a part of a top side of the battery 5. When removing the battery 5 from the battery storage unit 24, the user moves the stopper 24c to a position to retract the stopper 24c from the upper side of the battery 5. Thus, the battery 5 is slightly raised by the force of the compression spring 24a, allowing the user to easily remove the battery 5 from the battery storage unit 24.

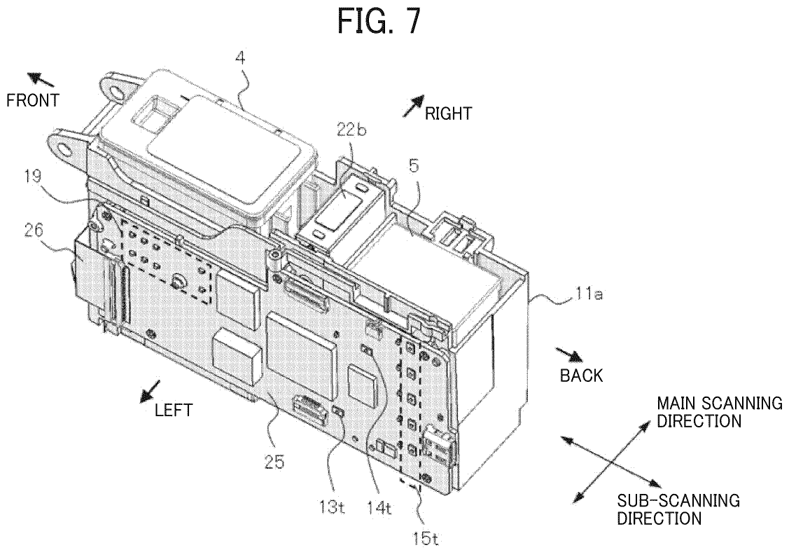

FIG. 7 is a diagram illustrating how the ink cartridge 4, the battery 5, and a control board 25 are mounted.

The ink cartridge storage unit 23, the battery storage unit 24, and the pressure assembly 22 are attached to an inner housing 11a. The ink cartridge 4 and the battery 5 are respectively attached to the ink cartridge storage unit 23 and the battery storage unit 24 that are disposed in the inner housing 11a.

The inner housing 11a holds the control board 25 on one side of the inner housing 11a. In the present embodiment, the inner housing 11a holds the control board 25 on a left side of the inner housing 11a. The inner housing 11a serves as a control board holder according to the present embodiment. The control board 25 includes electronic components such as a central processing unit (CPU) and memories. For example, the CPU drives the head 6, receives instructions through the operation keys, and executes processing in response to the instructions. Examples of the memories include, but are not limited to, a ROM and a random access memory (RAM).

The control board 25 has a planar portion and an edge portion. The planar portion refers to a wide face of the control board 25; whereas the edge portion refers to a face along a thickness direction of the control board 25. The planar portion of the control board 25 is disposed along a height direction of the inner housing 11a, which is the height direction of the HMP 100 and the direction perpendicular to the main scanning direction and the sub-scanning direction in FIG. 7. The control board 25 is disposed on the inner housing 11a such that the planar portion of the control board 25 faces the ink cartridge 4 and the battery 5 via the inner housing 11a in the main scanning direction.

The planar portion of the control board 25 has a side facing the ink cartridge 4 and the battery 5. In the following description, the side facing the ink cartridge 4 and the battery 5 may be referred to as a facing side.

The control board 25 includes terminals 13t, 14t, and 15t on another side opposite the facing side of the planar portion of the control board 25. The terminals 13t, 14t, and 15t electrically connect to the power button 13, the print button 14, and the accumulated print buttons 15 illustrated in FIG. 1, respectively. The LED display unit 19 illustrated in FIG. 1 is disposed at a front position of the control board 25.

FIG. 7 illustrates a flexible printed circuit (FPC) 26 that electrically connects the ink cartridge terminal 23b and the control board 25.

As described above, according to the present embodiment, the HMP 100 includes the ink cartridge 4 that includes the head 6, the battery 5 that drives the head 6, the control board 25 that controls the head 6, and the body unit 1 that holds the ink cartridge 4, the battery 5, and the control board 25. The HMP 100 performs printing on a recording medium with the body unit 1 moving on the recording medium. The ink cartridge 4 and the battery 5 are disposed on the straight line A extending in the sub-scanning direction perpendicular to the main scanning direction of the body unit 1. The control board 25 is disposed in the body unit 1 such that the facing side of the control board 25 is along the height direction of the HMP 100 and faces the ink cartridge 4 and the battery 5 in the main scanning direction.

As described above, the ink cartridge 4 and the battery 5 are removably attachable to the body unit 1.

Accordingly, the printing apparatus is provided that is downsized in height (i.e., in the height direction of the printing apparatus). The printing apparatus downsized in height is unlikely to be lifted or tilted from the recording medium while moving. In short, the printing apparatus thus provided exhibits a good operability.

As described above, the operation keys (specifically, the terminals 13t, 14t, and 15t that electrically connect to the power button 13, the print button 14, and the accumulated print buttons 15, respectively) are disposed on the other side opposite the facing side of the control board 25.

The operation keys thus gathered on one side of the HMP 100 downsizes the HMP 100 in the main scanning direction.

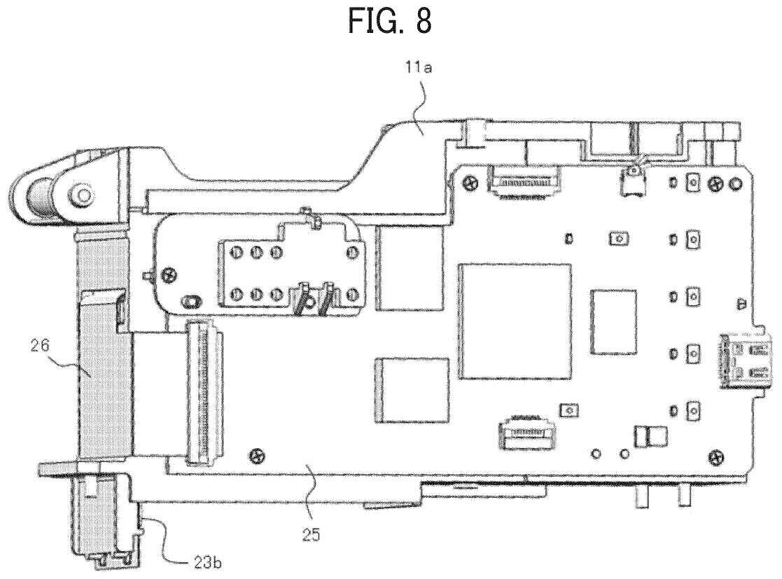

FIG. 8 is a diagram illustrating the ink cartridge terminal 23b and the control board 25. When a left side of the inner housing 11a is viewed obliquely from the front, the FPC 26 is located across a front side of the inner housing 11a and the control board 25 as illustrated in FIG. 8. One end of the FPC 26 is provided with the ink cartridge terminal 23b. Specifically, the FPC 26 is provided with the ink cartridge terminal 23b at a portion extending downward beyond a bottom side of the inner housing 11a. The other end of the FPC 26 is connected to the control board 25.

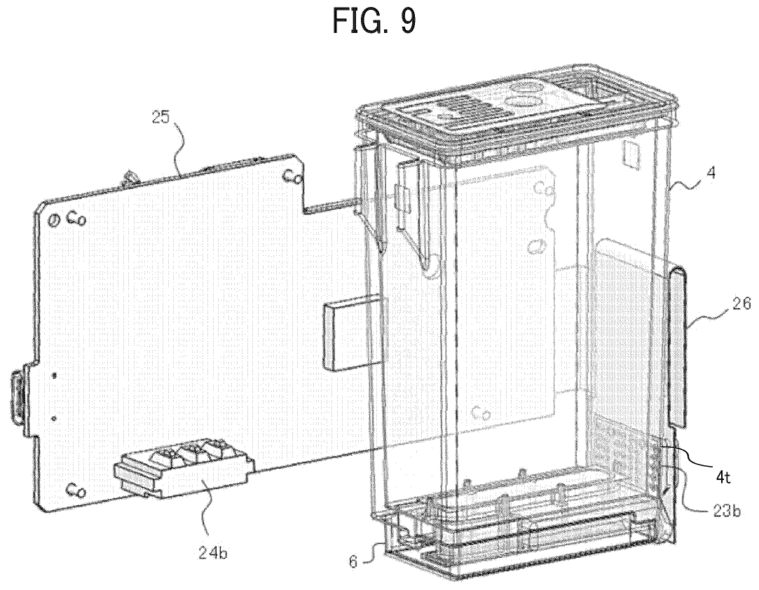

FIG. 9 is a diagram illustrating relative positions of the ink cartridge 4, the ink cartridge terminal 23b, and the control board 25. Specifically, FIG. 9 is a right perspective view of the ink cartridge 4, the ink cartridge terminal 23b, and the control board 25.

The ink cartridge 4 includes the head 6 at the bottom of the ink cartridge 4. When the ink cartridge 4 is mounted, the ink cartridge 4 is pressed into a position at which a terminal 4t of the ink cartridge 4 faces the ink cartridge terminal 23b.

The control board 25 includes the battery terminal 24b on the side facing the battery 5. The battery terminal 24b electrically connects to the battery 5.

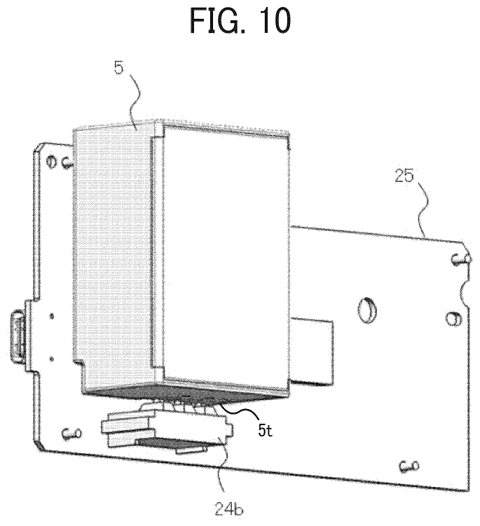

FIG. 10 is a diagram illustrating relative positions of the battery 5, the battery terminal 24b, and the control board 25. Specifically, FIG. 10 is a right perspective view of the battery 5, the battery terminal 24b, and the control board 25.

The battery terminal 24b is a terminal that is illustrated at the bottom of the battery storage unit 24 in FIG. 6. The battery terminal 24b is disposed directly on the control board 25. When the battery 5 is mounted, the relative positions of the battery 5, the battery terminal 24b, and the control board 25 are as illustrated in FIG. 10. The battery 5 is pressed into a position at which a terminal 5t of the battery 5 contacts the battery terminal 24b.

As described above, the battery terminal 24b is directly mounted on the control board 25. The battery terminal 24b is oriented upward to face the terminal 5t disposed at the bottom side of the battery 5 when the battery 5 is attached or removed. Accordingly, when the battery 5 is attached to or removed from the battery storage unit 24, the terminal 5t and the battery terminal 24b do not rub against each other, thus preventing damage to or deformation of the terminal 5t and the battery terminal 24b.

The battery terminal 24b directly mounted on the control board 25 obviates the need to provide another control board that connects the control board 25 and the battery 5 and a cable that connects the control boards. Such a configuration prevents a voltage drop between the control board 25 and the battery 5. Accordingly, printing is performed correctly without unevenness in the amount of ink discharged, for example. Such a configuration also contributes to downsizing the body unit 1.

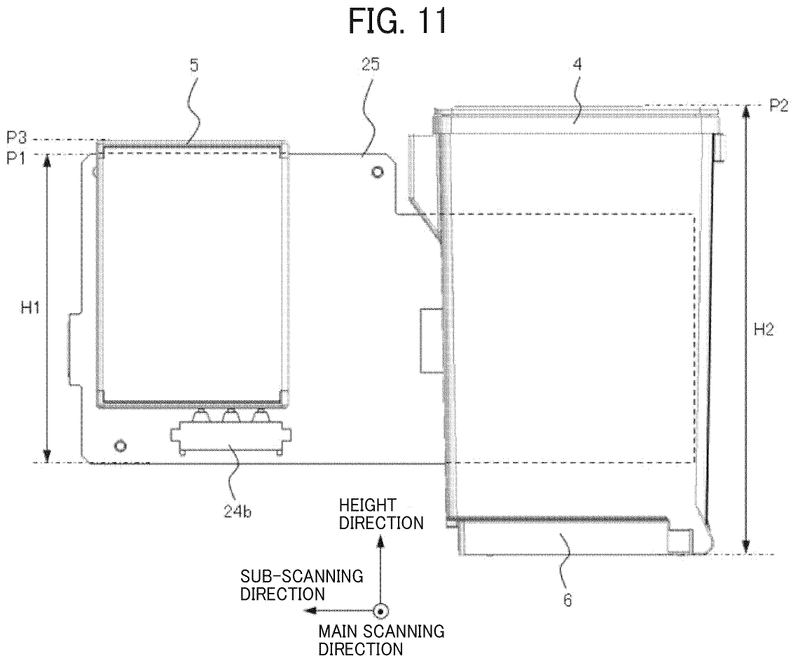

FIG. 11 is a diagram illustrating relative positions of the ink cartridge 4, the battery 5, and the control board 25 in the height direction of the HMP 100. Specifically, FIG. 11 is a right side view of the ink cartridge 4, the battery 5, and the control board 25.

Now, a description is given of the height of each of the ink cartridge 4, the battery 5, and the control board 25. Note that a height direction of each of the ink cartridge 4, the battery 5, and the control board 25 mounted in the body unit 1 is parallel to the height direction of the HMP 100. Initially, a description is given of the height of the battery 5. Since the battery terminal 24b is disposed on the control board 25, the battery 5 preferably has a height to such an extent that an upper end P3 as a head portion of the battery 5 slightly projects beyond an upper end P1 of the control board 25.

On the other hand, the ink cartridge 4 may need a certain height in relation to, e.g., the configuration of the head 6 and the capacity of the cartridge to contain ink. In short, preferably, the height of the ink cartridge 4 is not restricted by the height of the control board 25.

In view of the foregoing, in the present embodiment, the upper end P1 of the control board 25 in the height direction of the control board 25 is located lower than an upper end P2 of the ink cartridge 4 in the height direction of the ink cartridge 4 and the upper end P3 of the battery 5 in the height direction of the battery 5. Regarding the height, which is a length in the height direction, a height H1 of the control board 25 is smaller than a height H2 of the ink cartridge 4. Such a configuration attains the HMP 100 downsized in height compared to a typical HMP. The HMP 100 downsized in height has a lowered center of gravity. Accordingly, the HMP 100 is unlikely to be lifted or tilted from the recording medium while moving.

In the embodiment described above, the ink cartridge 4, the battery 5, and the control board 25 are mounted on the inner housing 11a, which is mounted on the body unit 1 of the HMP 100. However, the configuration in which the components are mounted is not limited to the foregoing configuration. Alternatively, for example, the ink cartridge 4, the battery 5, and the control board 25 may be directly mounted on the body unit 1 of the HMP 100, without the inner housing 11a.

In the embodiment described above, an inkjet recording system is exemplified as a printing system. However, the printing system is not limited to the inkjet recording system. Alternatively, the printing apparatus may employ another system such as a heat sensitive system or a thermal transfer system. In the embodiments of the present disclosure, the recording medium is not limited to a sheet of paper. The recording medium may be any printing object such as a corrugated cardboard, a cloth, a film made of resin, an object made of glass, rubber, or metal, a package, or an electronic substrate.

The embodiment described above is given as an example. Unique advantageous effects are achieved for each of the following aspects given below.

Initially, a description is given of a first aspect of the present disclosure.

According to the first aspect, a printing apparatus (e.g., the HMP 100) includes a removable member (e.g., the ink cartridge 4) that includes a printing unit (e.g., the head 6), a battery (e.g., the battery 5) that drives the printing unit, a control board (e.g., the control board 25) that controls the printing unit, and a body unit (e.g., the body unit 1) that holds the removable member, the battery, and the control board. The printing apparatus performs printing on a recording medium with the body unit moving on the recording medium. The removable member and the battery are disposed on a straight line (e.g., the straight line A) extending in a sub-scanning direction perpendicular to a main scanning direction of the body unit. The control board is disposed in the body with a side, as a facing side, of the control board being along a height direction of the printing apparatus and facing the removable member and the battery in the main scanning direction.

Now, a description is given of a second aspect of the present disclosure.

According to the second aspect, in the printing apparatus (e.g., the HMP 100) of the first aspect, the removable member (e.g., the ink cartridge 4) and the battery (e.g., the battery 5) are removably attachable to the body unit (e.g., the body unit 1).

According to the first and second aspects, the printing apparatus is provided that is downsized in height and exhibits a good operability.

Now, a description is given of a third aspect of the present disclosure.

According to the third aspect, the printing apparatus (e.g., the HMP 100) of the first or second aspect further includes an operation key (e.g., the terminals 13t, 14t, and 15t that electrically connect to the power button 13, the print button 14, and the accumulated print buttons 15, respectively) disposed on another side opposite the facing side of the control board 25 (e.g., the control board 25).

According to the third aspect, the operation keys are gathered on one side of the printing apparatus, thus downsizing the printing apparatus in the main scanning direction.

Now, a description is given of a fourth aspect of the present disclosure.

According to the fourth aspect, in the printing apparatus (e.g., the HMP 100) of any one of the first to third aspects, the control board (e.g., the control board 25) has an upper end (e.g., the upper end P1) in the height direction of the printing apparatus located lower than an upper end (e.g., the upper end P2) of the removable member (e.g., the ink cartridge 4) in the height direction of the printing apparatus and an upper end (e.g., the upper end P3) of the battery (e.g., the battery 5) in the height direction of the printing apparatus.

Now, a description is given of a fifth aspect of the present disclosure.

According to the fifth aspect, in the printing apparatus (e.g., the HMP 100) of the fourth aspect, the control board (e.g., the control board 25) has a length (e.g., the height H1) in the height direction of the printing apparatus smaller than a length (e.g., the height H2) of the removable member (e.g., the ink cartridge 4) in the height direction of the printing apparatus.

According to the fourth aspect and the fifth aspect, the printing apparatus downsized in height has a lowered center of gravity. Accordingly, the printing apparatus is provided that is unlikely to be lifted or tilted from the recording medium while moving and that exhibits a good operability.

Now, a description is given of a sixth aspect of the present disclosure.

According to the sixth aspect, in the printing apparatus (e.g., the HMP 100) of any one of the first to fifth aspect, the control board (e.g., the control board 25) includes a terminal (e.g., the battery terminal 24b) disposed directly on the facing side to electrically connect to the battery (e.g., the battery 5).

Now, a description is given of a seventh aspect of the present disclosure.

According to the seventh aspect, in the printing apparatus (e.g., the HMP 100) of the sixth aspect, the terminal (e.g., the battery terminal 24b) of the control board (e.g., the control board 25) is disposed to face a terminal (e.g., the terminal 5t) of the battery (e.g., the battery 5) in a direction in which the battery is attached to or removed from the body unit (e.g., the body unit 1).

According to the sixth and seventh aspects, when the battery is attached to or removed from the body unit, the terminals do not rub against each other, thus preventing damage to or deformation of the terminals.

Now, a description is given of an eighth aspect of the present disclosure.

According to the eighth aspect, in the printing apparatus (e.g., the HMP 100) of any one of the first to seventh aspects, the removable member (e.g., the ink cartridge 4) includes a terminal (e.g., the terminal 4t). The body unit (e.g., the body unit 1) includes a terminal (e.g., the ink cartridge terminal 23b) that electrically connects to the terminal of the removable member. The body unit includes a pressure assembly (e.g., the pressure assembly 22) disposed between the removable member and the battery (e.g., the battery 5) to press the terminal of the removable member against the terminal of the body unit.

According to the eighth aspect, an incomplete electrical connection between the removable member and the body unit is prevented.

Now, a description is given of a ninth aspect of the present disclosure.

According to the ninth aspect, in the printing apparatus (e.g., the HMP 100) of any one of the first to eighth aspects, the control board (e.g., the control board 25) is proximate to a side of the body unit (e.g., the body unit 1) in the main scanning direction.

Now, a description is given of a tenth aspect of the present disclosure.

According to the tenth aspect, the printing apparatus (e.g., the HMP 100) of the ninth aspect further includes a print instruction unit (e.g., the print button 14) and a power operation unit (e.g., the power button 13) disposed on the side of the body unit (e.g., the body unit 1) proximate to the control board (e.g., the control board 25).

Now, a description is given of an eleventh aspect of the present disclosure.

According to the eleventh aspect, in the printing apparatus (e.g., the HMP 100) of the tenth aspect, the print instruction unit (e.g., the print button 14) is disposed above a center of the body unit (e.g., the body unit 1) in a height direction of the body unit; whereas the power operation unit (e.g., the power button 13) is disposed below the center of the body unit in the height direction of the body unit.

Now, a description is given of a twelfth aspect of the present disclosure.

According to the twelfth aspect, the printing apparatus (e.g., the HMP 100) of the tenth or eleventh aspect further includes a memory (e.g., the ROM 50 illustrated in FIG. 14) disposed in the body unit (e.g., body unit 1) and a print information retrieval unit (e.g., the accumulated print button 15) disposed on the side of the body unit (e.g., the body unit 1), on which the print instruction unit (e.g., the print button 14) and the power operation unit (e.g., the power button 13) are disposed, to retrieve print information from the memory.

Now, a description is given of a thirteenth aspect of the present disclosure.

According to the thirteenth aspect, in the printing apparatus (e.g., the HMP 100) of the twelfth aspect, the print information retrieval unit (e.g., the accumulated print button 15) is adjacent to the print instruction unit (e.g., the print button 14) in the sub-scanning direction on the side of the body unit (e.g., the body unit 1).

Now, a description is given of a fourteenth aspect of the present disclosure.

According to the fourteenth aspect, the printing apparatus (e.g., the HMP 100) of the tenth aspect further includes a display unit (e.g., the display screen 191) disposed on the side of the body unit (e.g., the body unit 1), on which the print instruction unit (e.g., the print button 14) and the power operation unit (e.g., the power button 13) are disposed, to display at least one of print information and a state of the printing apparatus.

Now, a description is given of a fifteenth aspect of the present disclosure.

According to the fifteenth aspect, the printing apparatus (e.g., the HMP 100) of the tenth aspect further includes a printing-unit cover member (e.g., the head cover 3) that is openably closable with respect to the printing unit (e.g., the head 6) and a printing-unit-cover operation unit (e.g., the head cover opening/closing lever 31) disposed on the side of the body unit (e.g., the body unit 1), on which the print instruction unit (e.g., the print button 14) and the power operation unit (e.g., the power button 13) are disposed, to move the printing-unit cover member.

According to the ninth to fifteenth aspects, the operation units such as the operation keys are gathered together on one side of the printing apparatus, thus downsizing the printing apparatus in the main scanning direction.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2021-045430, filed on Mar. 19, 2021, in the Japan Patent Office, the entire disclosure of which is hereby incorporated by reference herein.

### REFERENCE SIGNS LIST

100 HMP (Handheld mobile inkjet printer)
1 Body unit
11a Inner housing
2 Top cover
3 Head cover (Printing-unit cover member)
4 Ink cartridge (Removable member)
5 Battery
13 Power button (Power operation unit)
14 Print button (Print instruction unit)
15 Accumulated print button (Print information retrieval unit)
19 LED display unit
25 Control board

1. A printing apparatus comprising:
a removable member including a printing device;
a battery configured to drive the printing device;
a control board configured to control the printing device; and
a body housing configured to hold the removable member, the battery, and the control board,
the removable member and the battery on a line extending in a sub-scanning direction perpendicular to a main scanning direction of the body housing, and
the control board included in the body housing with a side, as a facing side, of the control board being along a vertical direction of the printing apparatus and facing the removable member and the battery in the main scanning direction.

2. The printing apparatus according to claim 1, wherein the removable member and the battery are configured to be removably attachable to the body housing.

3. The printing apparatus according to claim 1, further comprising:
an operation key on a second side opposite the facing side of the control board.

4. The printing apparatus according to claim 1, wherein the control board has an upper end in the vertical direction of the printing apparatus located lower than an upper end of the removable member in the vertical direction of the printing apparatus and an upper end of the battery in the vertical direction of the printing apparatus.

5. The printing apparatus according to claim 4, wherein the control board has a length in the vertical direction of the printing apparatus smaller than a length of the removable member in the vertical direction of the printing apparatus.

6. The printing apparatus according to claim 1, wherein the control board includes a terminal directly on the facing side, the terminal configured to electrically connect the control board to the battery.

7. The printing apparatus according to claim 6, wherein the terminal of the control board faces a terminal of the battery in a direction in which the battery is attached to or removed from the body housing.

8. The printing apparatus according to claim 1, wherein
the removable member includes a terminal;
the body housing includes a terminal configured to electrically connect to the terminal of the removable member; and
the body housing includes a pressure assembly between the removable member and the battery, the pressure assembly configured to press the terminal of the removable member against the terminal of the body housing.

9. The printing apparatus according to claim 1, wherein the control board is proximate to a side of the body housing in the main scanning direction.

10. The printing apparatus according to claim 9, further comprising:
a print key and a power operation key on the side of the body housing.

11. The printing apparatus according to claim 10, wherein
the print key is above a center of the body housing in a vertical direction of the body housing; and
the power operation key is below the center of the body housing in the vertical direction of the body housing.

12. The printing apparatus according to claim 10, further comprising:
a memory included in the body housing; and
a print information retrieval key on the side of the body housing configured to cause retrieval of print information from the memory.

13. The printing apparatus according to claim 10, further comprising:
a display device on the side of the body housing, the display device configured to display at least one of print information and a state of the printing apparatus.

14. The printing apparatus according to claim 10, further comprising:
a printing device cover member configured to be openable with respect to the printing device; and
a printing device-cover operation mechanism on the side of the body housing, the printing-device-cover operation mechanism configured to move the printing device cover member.

15. A printing apparatus body comprising:
a removable-member storage configured to store a removable member that includes a printing device;
a battery storage configured to store a battery configured to drives the printing device;
a control board holder configured to hold a control board configured to control the printing device; and
a body housing having an opening portion which exposes the printing device,
the removable-member storage and the battery storage being on a line extending in a sub-scanning direction perpendicular to a main scanning direction of the body housing,
the control board holder included in the body housing, the control board holder configured to hold the control board with a side of the control board being along a vertical direction of the printing apparatus body and facing the removable-member storage and the battery storage in the main scanning direction.
